(19) United States
(12) Patent Application Publication
(10) Pub. No.: US 2017/0057117 A1
(43) Pub. Date: Mar. 2, 2017

(54) CHIP SIZE CONTROL SYSTEM FOR LOG CHIPPING MACHINE

(71) Applicant: Astec Industries, Inc., Chattanooga, TN (US)

(72) Inventors: Malcolm Angus Windrim, Lavington (AU); Luke Ricker, Eugene, OR (US)

(73) Assignee: Astec Industries, Inc., Chattanooga, TN (US)

(21) Appl. No.: 15/241,787

(22) Filed: Aug. 19, 2016

Related U.S. Application Data
(60) Provisional application No. 62/213,479, filed on Sep. 2, 2015.

(51) Int. Cl. B27L 11/00; B02C 18/22; B02C 25/00; B27L 11/02

(52) U.S. Cl. CPC B27L 11/002; B27L 11/02; B02C 18/225; B02C 25/00

(57) ABSTRACT

A log chipping machine includes a frame having a long axis and a rotating chipping mechanism having an axis of rotation that is oblique to the long axis of the frame of the machine. The machine also includes a log advance system that is adapted to advance a log to the chipping mechanism, in a processing direction that is generally parallel to the long axis of the frame. The log advance system includes an upper feed assembly. A control system includes a lifting assembly and a controller assembly. The lifting assembly is adapted to move the upper feed assembly with respect to the frame between an engagement position in which the upper feed assembly contacts the log to advance it towards the chipping mechanism and a raised position in which the upper feed assembly is above and out of contact with the log. The controller assembly is operatively connected to the lifting assembly and adapted to cause the lifting assembly to move the upper feed assembly from the engagement position to the raised position intermittently in order to orient the log axis in a generally parallel relationship with the long axis of the frame as the log is being reduced.

### CROSS-REFERENCE TO RELATED APPLICATION

This application claims the benefit of U.S. Provisional Patent Application No. 62/213,479 which was filed on Sep. 2, 2015.

### FIELD OF THE INVENTION

The present invention relates generally to a chipping machine for converting a log into chips and to a system for controlling the size of the chips produced.

### BACKGROUND OF THE INVENTION

The processing of logs into wood chips requires an apparatus to remove the bark and limbs from the logs and an apparatus to reduce the partially processed logs into chips. Bark is considered to be a contaminant in the chips, so it is desirable to completely remove all bark prior to the chipping process. Debarking assemblies frequently comprise two or more rotating shafts to which are attached multiple flail chains, and it is common for the debarking assembly to be combined with a wood chipping machine. Logs are introduced into the space between the shafts of the debarking assembly in a direction normal to the axes of rotation of the shafts. Typically, the shafts are arranged so that at least one is an upper shaft and another is a lower shaft, although they may be laterally offset from each other. In such a device, the feed line along which the logs are passed through the machine is located between an upper shaft and a lower shaft. In order to remove the bark and limbs from the log, at least some of the flail chains on the upper shaft must reach down along the sides of the log to at least the mid-point. Similarly, at least some of the flail chains on the lower shaft must reach upwardly along the sides of the log to the mid-point. The length of the flail chains on each shaft is dictated by the size of the smallest log that is intended to be debarked.

The partially processed logs may be processed into chips by a wood chipping machine. The use of such a machine, either in combination with or separately from a debarking apparatus, avoids the environmental and other problems associated with burning trees and brush or with depositing them in a landfill. Furthermore, by reducing wood to chips of a useful size, a wood chipping machine may be employed to produce a valuable chip product.

Wood chips can be used as mulch or fuel. They can also be used as raw material for creating a pelletized fuel product or as raw material in a chemical pulp process. Wood chips that are intended for use as fuel or in a pelletizing process may first need to be dried. It is desirable that such chips have a uniform chip thickness and a high surface area to volume ratio. It is also desirable that chips which are intended for use in a pulp process be of a uniform size. Ideal pulp chips fall into a narrow thickness range so that they can be heated to delignify in a uniform manner. Long and narrow chips and very small chips are undesirable because they can plug the pulp process screens and overheat, thereby damaging the wood fibers and reducing the strength of the pulp.

Most wood chipping machines are either drum chippers or disc chippers. Drum chippers include knives mounted around the circumferential wall of a cylindrical drum that cut across the wood feed stock in a path that varies with respect to the orientation of the grain of the feed stock to the drum. Disc chippers include knives mounted on a rotating disc that cut across the grain of the wood stem generally perpendicular to the direction of the grain. Such machines also include a log advance system that typically comprises an upper feed assembly including at least one upper feed roller located to engage the top of the log to be processed and a plurality of lower feed assemblies including lower feed rollers that engage the bottom and/or sides of the log to be processed. Rotation of the upper and lower feed rollers causes the log to advance into the disc chipper. Disc chippers can create chips of a generally uniform size, but only if certain parameters of the chipping operation are properly controlled.

Best results are achieved by operating a disc-type wood chipping machine in a controlled manner that coordinates the knife extension, the number of knives and the rotational speed of the chipper disc with the speed of the upper feed roller and the feed angle of the tree stem. The speed of the upper feed roller and the lower feed rollers are set so that the tree stem advances at a rate that permits each knife in the rotating disc to pass across the tree stem at a depth predetermined to cut a properly sized chip. If the log feed speed (determined by the rotational rate of the feed rollers) is too slow, the chip size will be too small. If the log feed speed is too fast, the end of the tree stem will prematurely rub against the chipper disc, causing friction and wear. Sometimes when the tree stem is engaged with the chipper disc, the knives will pull the tree stem toward the chipper disc as the knives cut material from the end of the log, thereby misaligning the log with respect to the chipper disc.

In a disc-type wood chipping machine, the chipper disc is positioned so that its cutting face is at an angle to the processing direction of the log. This angle is referred to as the spout angle. The typical spout angle that establishes a desirable chip cutting action is in the range of 30°-40°. At larger spout angles the chip length to thickness ratio decreases and undesirable chip “pins” and “fines” are produced. If the spout angle is too small, the chips are cut nearly parallel to the grain of the log, thereby creating long oversized chips.

Because of the need to feed large diameter logs, the chipper disc feed opening is large. As a log is cut by the rotating chipper disc knives, the cutting forces tend to pull the end of the log toward the perimeter of the chipper disc and against an anvil wear plate located on the chipper disc perimeter side of the feed opening. Sometimes when a shortened log is advancing through the large feed opening in a position opposite the anvil wear plate, the chipper disc cutting forces can cause the shortened log to pivot toward the anvil side instead of moving generally laterally, because the other end of the shortened log is restrained by the grip of the upper feed roller against the lower feed rollers. The pivoted position of the shortened log results in a shallow spout angle. This is an especially pronounced phenomenon with the last short section of the log.

### Advantages of the Invention

Among the advantages of a preferred embodiment of the invention is that it provides a system for controlling the feed of the log into the chipper disc in a way that maintains proper processing alignment of the log, maintains appropriate log feed velocity, and significantly reduces the production of oversize chips resulting from chipping at spout angles that are too small.

The inventors have determined that lifting the upper feed roller at an appropriate time and for an appropriate period of time will permit the restrained end of a pivoted shortened log to realign to the desired spout angle and will not adversely affect the chipping operation when the log is properly aligned. Maintaining the correct spout angle significantly reduces the creation of undesirable long oversize chips. The invention comprises an automatic control system that will lift the upper feed roller periodically to allow for re-alignment and re-orientation of a misaligned log, without operator interaction. This control system will automatically lift the upper feed roller and hold it in an upper position for a predetermined period of time. Then, the system will automatically lower the upper feed roller to engage the log, thus allowing a shortened log to shift over to the correct alignment. It has been found that this brief period during which the upper feed roller is lifted out of contact with the log does not significantly reduce the log feed speed toward the chipper disc.

Other advantages and features of this invention will become apparent from an examination of the drawings and the ensuing description.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity. Several terms are specifically defined herein. These terms are to be given their broadest possible construction consistent with such definitions, as follows:

The terms “above”, “upwardly” and similar terms, when used in reference to a relative direction on or with respect to a log chipping machine or a combination debarking and chipping machine, or a component or portion of such a machine, refer to a relative direction that is farther away from the surface on which the machine is placed in order to process logs.

The term “processing direction” refers to the direction of travel of a log for processing through a log chipping machine or a combination debarking and chipping machine.

The term “front end” and similar terms refer to the end of a log chipping machine or a combination debarking and chipping machine, or a component or portion of such a machine, which is nearest the point at which a log to be processed is introduced into the machine.

The terms “forward”, “in front of”, and similar terms, as used herein to describe a relative position or direction on or in connection with a log chipping machine, or a combination debarking and chipping machine, or a component of such a machine, refer to a relative position or direction towards the front end of the machine.

The terms “back end”, “rear end” and similar terms refer to the end of a log chipping machine or a combination debarking and chipping machine, or a component or portion of such a machine, which is farther from the front end of the machine, component or portion thereof.

The terms “rearward”, “behind”, and similar terms, as used herein to describe a relative position or direction on or in connection with a log chipping machine or a combination debarking and chipping machine or a component of such a machine, refer to a relative position or direction towards the rear end of the machine.

The term “actuator” refers to an electric, hydraulic, electro-hydraulic or mechanical device that is adapted to apply a force to a component of a log chipping machine or a combination debarking and chipping machine with respect to the housing, frame or another component of the machine.

The term “linear actuator” refers to an actuator that generates force which is directed in a straight line. Common examples of linear actuators include double-acting hydraulic or pneumatic actuators which include a cylinder, a piston within the cylinder, and a rod attached to the piston. By increasing the pressure within the cylinder on one side of the piston (over that on the opposite side of the piston), the rod will extend from the cylinder or retract into the cylinder.

The term “log axis” refers to the long axis of a log that is being processed by a log chipping machine or a combination debarking and chipping machine.

The term “orient”, as used in connection with the operation of the invention to define the relationship between the log axis and the long axis of the frame of the log chipping machine, means to maintain or re-orient the log axis in a generally parallel relationship with the long axis of the frame as the log is being reduced.

### SUMMARY OF THE INVENTION

The invention comprises a log chipping machine including a control system for controlling the feed of a log into the chipping mechanism in a way that maintains proper feed alignment of the log, maintains appropriate log feed speed into the chipping mechanism, and significantly reduces the production of oversize chips resulting from chipping at spout angles that are too small.

The log chipping machine includes a frame having a long axis and a rotating chipping mechanism which has an axis of rotation that is oblique to the long axis of the frame. The log chipping machine also includes a log advance system that is adapted to advance a log to the chipping mechanism, in a processing direction that is generally parallel to the long axis of the frame. This log advance system includes an upper feed assembly. A control system includes a lifting assembly and a control assembly. The lifting assembly is adapted to move the upper feed assembly with respect to the frame between an engagement position in which the upper feed assembly contacts the log to advance it towards the chipping mechanism and a raised position in which the upper feed assembly is above and out of contact with the log. The controller assembly is operatively connected to the lifting assembly and adapted to cause the lifting assembly to move the upper feed assembly from the engagement position to the raised position intermittently in order to orient the log axis in a generally parallel relationship with the long axis of the frame as the log is being reduced.

Preferably, this control system includes a controller and a timer, so that the lifting assembly may lift the upper feed assembly at predetermined intervals during operation of the log advance system to advance a log towards the chipping mechanism. The controller causes the lifting assembly to lift the upper feed assembly out of contact with the log and to maintain the upper feed assembly in a lifted position for a predetermined time. Then, the controller will automatically lower the upper feed assembly into engagement with the log. The preferred system includes a controller interface by which an operator may set a first interval within a first predetermined range of intervals to define the time period between each actuation of the lifting assembly to move the upper feed assembly to the raised position, and a second interval within a second predetermined range of intervals to define the time period that the upper feed assembly will be maintained in the raised position. The timer insures that the steps of the control operation are carried out in the selected time intervals. Preferably, the first predetermined range of intervals is 1.0-10.0 seconds, and the first interval may be selected in increments of 0.1 second within this first range. It is also preferred that the default interval within the first predetermined range is 3.0 seconds. Furthermore, it is preferred that the second predetermined range of intervals is 1.0-3.0 seconds, and the second interval may be selected in increments of 0.1 second within this second range. The preferred default interval within the second predetermined range is 1.0 second.

In order to facilitate an understanding of the invention, the preferred embodiments of the invention, as well as the best mode known by the inventors for carrying out the invention, are illustrated in the drawings, and a detailed description thereof follows. It is not intended, however, that the invention be limited to the particular embodiments described or to use in connection with the apparatus illustrated herein. Therefore, the scope of the invention contemplated by the inventors includes all equivalents of the subject matter described herein, as well as various modifications and alternative embodiments such as would ordinarily occur to one skilled in the art to which the invention relates. The inventors expect skilled artisans to employ such variations as seem to them appropriate, including the practice of the invention otherwise than as specifically illustrated and described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiments of the invention are illustrated in the accompanying drawings, in which like reference numerals represent like parts throughout, and wherein:

FIG. 1 is a side view, partially in section, of a combination debarking and chipping machine that may be equipped with the control system of the invention.

FIG. 2 is a partial perspective view of an upper feed assembly of a log chipping machine, showing certain portions of the control system of the invention.

FIG. 3 is a side view of a portion of the upper feed assembly shown in FIG. 2.

FIG. 4 is a top view of a portion of a log chipping machine showing an upper feed assembly and a chipping mechanism with a log being fed into the chipping mechanism at the desired orientation.

FIG. 5 is a top view of the portion of the log chipping machine shown in FIG. 4, with the log in a misaligned position.

FIG. 6 is a top view of the portion of the log chipping machine shown in FIGS. 4 and 5, after the log has been properly aligned according to the invention.

### DESCRIPTION OF THE PREFERRED EMBODIMENTS OF THE INVENTION

This description of preferred embodiments of the invention is intended to be read in connection with the accompanying drawings, which are to be considered part of the entire written description of this invention. The drawing figures are not necessarily to scale, and certain features of the invention may be shown exaggerated in scale or in somewhat schematic form in the interest of clarity and conciseness.

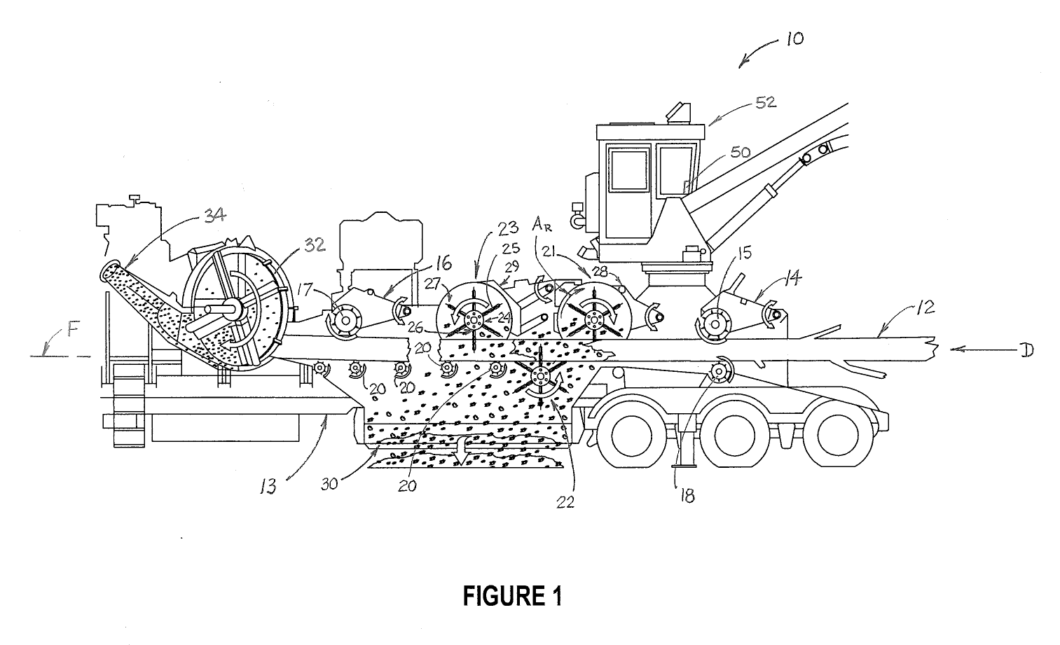

As shown in FIG. 1, machine 10 is a combination debarker and log chipping machine that is adapted to process a log such as log 12. Machine 10 includes frame 13 on which the operating components of the machine are mounted. Frame 13 has a long axis F that is shown in FIG. 1. The log is carried through the machine in processing direction D which is generally parallel to frame axis F by a log advance system comprising a plurality of rotating feed rollers. Upper debarker feed assembly 14 is pivotally mounted on the frame 13 of the machine above the log and is adapted to rotate feed roller 15 in a clockwise direction (as shown in FIG. 1). Similarly, upper chipping feed assembly 16 is pivotally mounted on the frame 13 of the machine above the log and is adapted to rotate feed roller 17 in a clockwise direction (as shown in FIG. 1). Lower feed assemblies are mounted below the log and includes rollers 18 and 20 that are adapted to rotate in a counterclockwise direction (as shown in FIG. 1). Upper feed roller 15 and lower feed roller 18 cooperate to move log 12 into contact with debarking assemblies 21, 22 and 23. Each of the debarking assemblies includes a rotating shaft 24 to which are attached a plurality of flail chains 25. Each rotating shaft 24 rotates about an axis of rotation that is perpendicular to the plane of the page of FIG. 1. Each flail chain has a fixed end 26 that is attached to a shaft and a free end 27. Each flail chain is of a length that defines an arc of rotation A_{R} of the free end 27 of the flail chain 25. Rotation of the shafts causes the chains to flail the bark from the log. As shown in FIG. 1, the shaft of first upper debarking assembly 21 rotates in a clockwise direction, while the shafts of lower debarking assembly 22 and second upper debarking assembly 23 rotate in a counterclockwise direction. Upper debarking assemblies 21 and 23 include housings 28 and 29 respectively that are pivotally mounted to the frame of machine 10. Much of the bark that is removed by the flail assembly falls into bark removal conveyor 30 for removal from the machine. A flailed log advance system comprising upper feed roller 17 and lower feed rollers 20 cooperate to advance the flailed log into a chipping mechanism comprising chipper disc 32, which rotates in a clockwise direction (as shown in FIG. 1) to reduce the log to chips that pass out of the machine through chute 34.

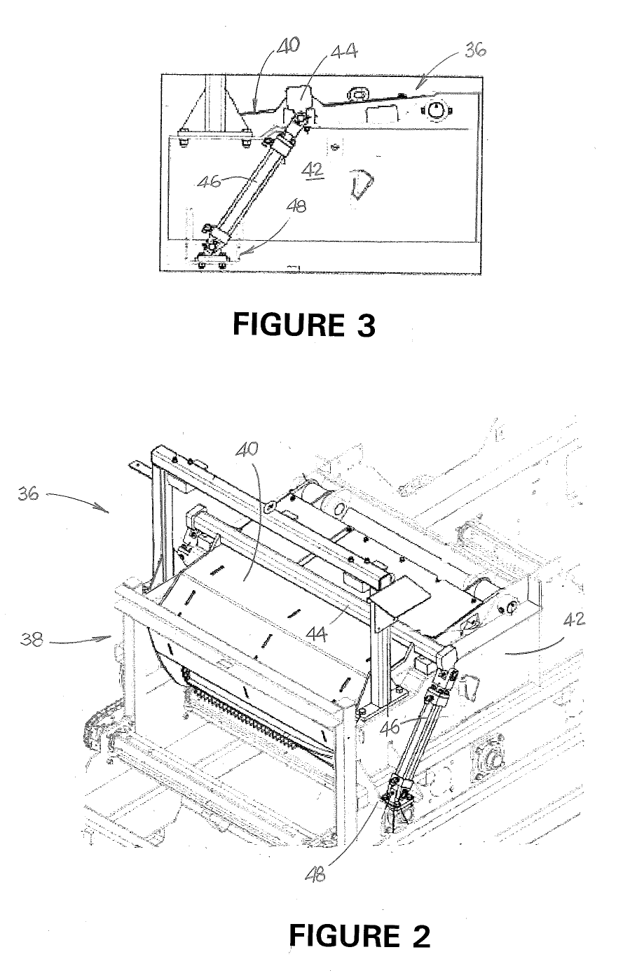

FIGS. 2 and 3 illustrate a portion of an upper feed assembly 36 which is similar to upper chipping feed assembly 16 of machine 10, as well as certain portions of the control system of the invention. These drawings show upper feed assembly 36 in some detail, including housing 38 that partially encloses an upper feed roller (not shown, but substantially similar to upper feed roller 17 of machine 10). Housing 38 includes top portion 40 and a pair of sidewalls, only one of which, sidewall 42, is shown in the drawings. Top bar 44 extends across the top of the housing from one side to the opposite side of the upper feed assembly, as best shown in FIG. 2.

The lifting assembly comprises a pair of linear actuators, only one of which, linear actuator 46, is shown in the drawings. These linear actuators are attached between frame components of the log chipping machine, only one of which, frame component 48, is shown in the drawings, and top bar 44 of upper feed assembly 36 on opposite sides of assembly 36. The second actuator is located on the opposite side of upper feed assembly 36 from actuator 46 and is also disposed between a frame component of the log chipping machine and top bar 48 in the same angular configuration as that of actuator 46.

A controller assembly, such as controller assembly 50 shown in FIG. 1, which is located in operator's station 52, is operatively connected to the lifting assembly and adapted to cause the lifting assembly to move the upper feed assembly from an engagement position in which the upper feed roller of the upper feed assembly contacts the log to advance it towards the chipping mechanism and a raised position in which the upper feed assembly is above the log and the upper feed roller is out of contact with the log. Preferably, control assembly 50 includes a programmable controller and a timer. The inventors have found that moving the upper feed assembly from the engagement position to the raised position intermittently will orient the log axis in a generally parallel relationship with the long axis of the frame of the log chipping machine as the log is being reduced into chips. Preferably, the controller assembly is also operatively connected to the log advance system and is adapted to cause the log advance system to stop advancing the log to the chipping mechanism while the upper feed assembly is in the raised position.

Preferably, the controller assembly is adapted to cause the lifting assembly to move the upper feed assembly from the engagement position to the raised position for a first predetermined time interval and to maintain the upper feed assembly at the raised position for a second predetermined time interval, at the end of which second predetermined time interval the controller will cause the lifting assembly to move the upper feed assembly from the raised position to the engagement position. After the lifting assembly has moved the upper feed assembly from the raised position to the engagement position and thereafter a predetermined engagement period of time has elapsed, the controller assembly will preferably cause the lifting assembly to move the upper feed assembly from the engagement position to the raised position.

It is also preferred that the controller assembly comprise a programmable controller which is operatively connected to a controller interface that an operator may use to set a first interval within a first predetermined range of intervals to define the time period between each actuation of the lifting assembly to move the upper feed assembly to the raised position and a second interval within a second predetermined range of intervals to define the time period that the upper feed assembly will be maintained in the raised position, and a timer for measuring the first interval and the second interval. Furthermore, it is preferred that the first predetermined range of intervals is 1.0-10.0 seconds, and that the first interval may be selected in increments of 0.1 second within this first range. It is also preferred that the second predetermined range of intervals is 1.0-3.0 seconds, and that the second interval may be selected in increments of 0.1 second within this second range. The inventors have found that very good results can be obtained when the controller will cause the lifting assembly to move the upper feed assembly from the engagement position to the raised position every 3.0 seconds and will hold the upper feed assembly at the raised position for 1.0 seconds, after which the controller will move the upper feed assembly from the raised position to the engagement position.

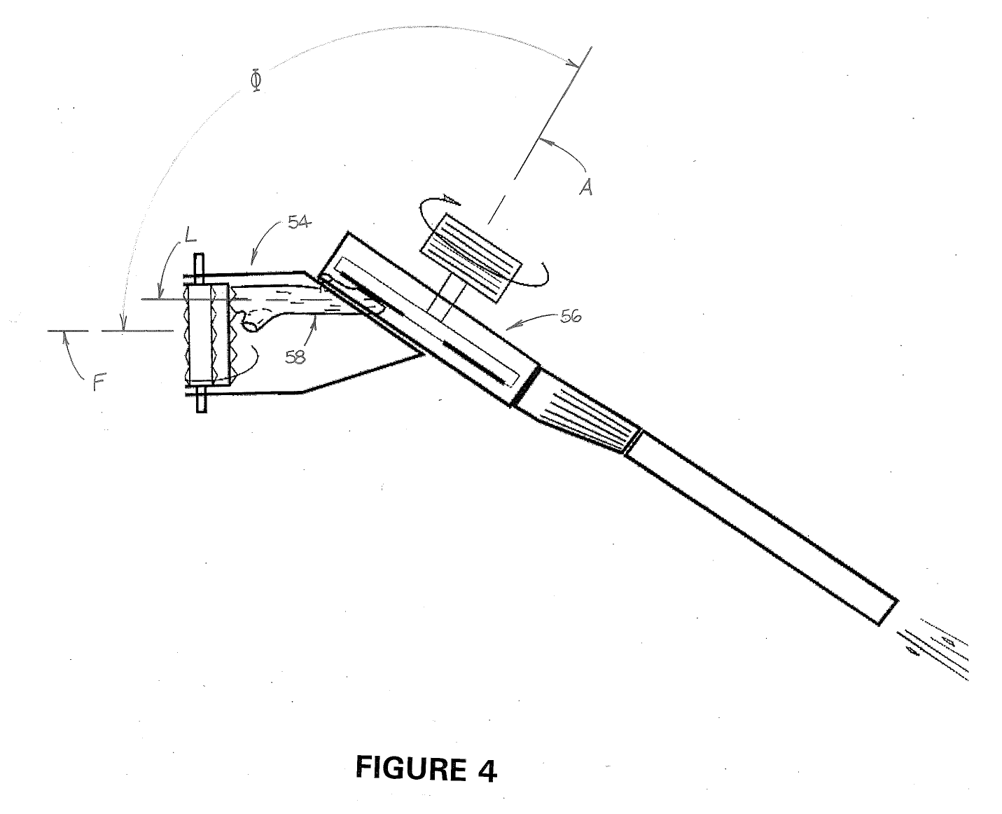

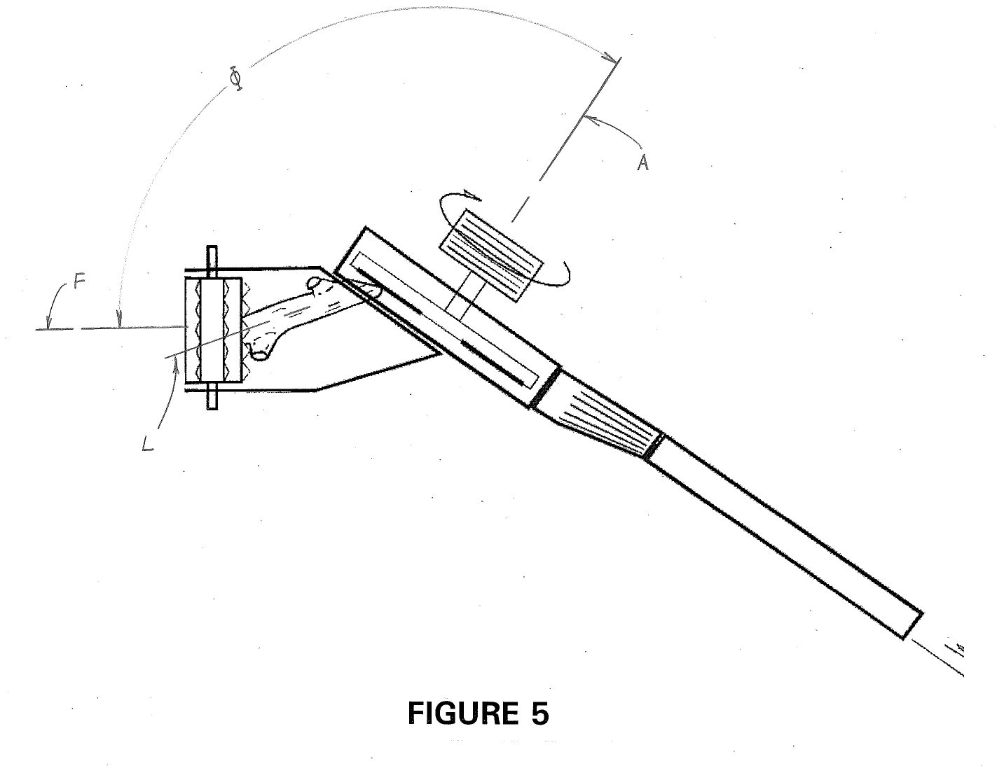

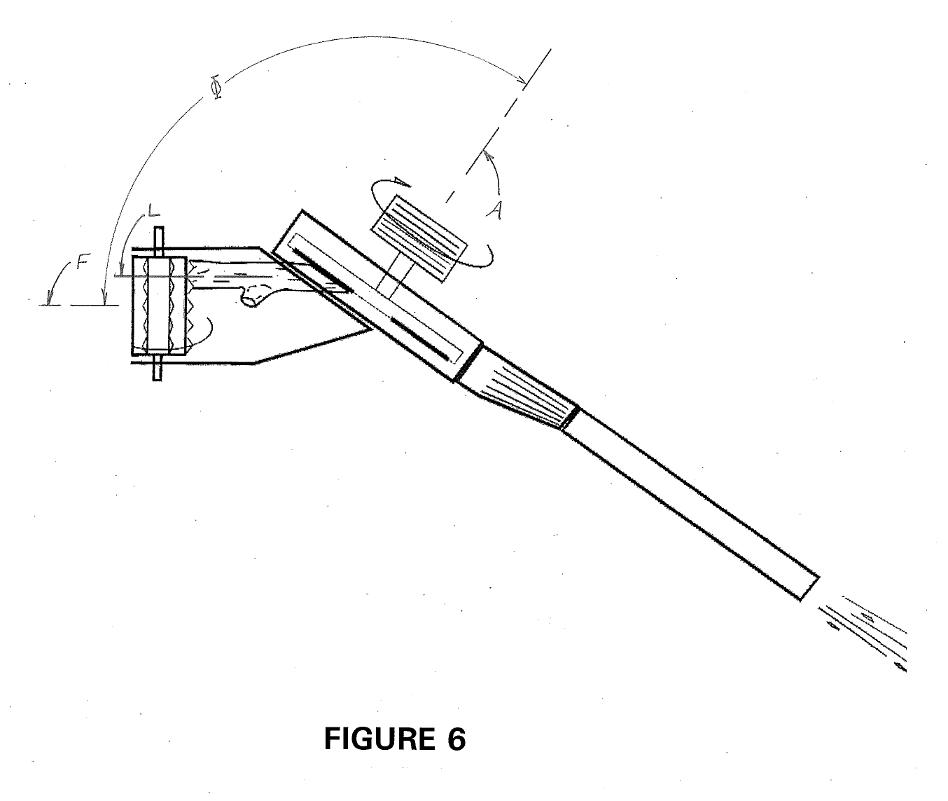

FIGS. 4-6 illustrate a portion of a log chipping machine showing upper feed assembly 54 and chipping mechanism 56 with a log being fed into the chipping mechanism. As shown therein, chipping mechanism 56 has an axis of rotation A that is oblique to the long axis F of the frame. In other words, chipping mechanism 56 is oriented with respect to the frame of the log chipping machine so that its axis of rotation A forms an angle Φ with respect to long axis F of the machine frame. As shown in FIG. 4, log 58 having log axis L is being fed into the chipping mechanism at the desired orientation. In the orientation shown in FIG. 4, log axis L is generally parallel to the long axis F of the frame. Frequently when the log is shortened, it will misalign, as shown in FIG. 5, so that long axis L is not parallel to frame axis F. However, the inventors have found that moving the upper feed assembly from the engagement position to the raised position intermittently will orient the log axis L in a generally parallel relationship with the long axis of the frame F of the log chipping machine as the log is being reduced into chips, as shown in FIG. 6.

The invention also includes a method for operating a log chipping machine having a lifting assembly and a rotating chipping mechanism as described herein, to reduce a log having a log axis. The method comprises operating the rotating chipping mechanism, advancing the log to the chipping mechanism and causing the lifting assembly to move the upper feed assembly from the engagement position to the raised position intermittently. Preferably, the method includes causing the log advance system to stop advancing the log to the chipping mechanism while the upper feed assembly is in the raised position. It is also preferred that the upper feed assembly be moved from the engagement position to the raised position every 3.0 seconds and that the upper feed assembly be held at the raised position for 1.0 seconds, after which time, the upper feed assembly is moved from the raised position to the engagement position.

The inventors have found that lifting the upper feed assembly at an appropriate time and for an appropriate period of time will permit the restrained end of a pivoted shortened log to realign to the desired spout angle and will not adversely affect the chipping operation when the log is properly aligned. The automatic control system of a preferred embodiment of the invention will lift the upper feed assembly periodically to allow for re-alignment of a misaligned log, and will hold the upper feed assembly in a raised position for a short period of time. Then, the system will automatically lower the upper feed assembly so that its feed roller will engage the log, thus allowing a shortened log to shift over to the correct alignment. It has been found that this brief period during which the upper feed assembly is lifted out of engagement with the log does not significantly reduce the log feed speed toward the chipping mechanism.

Although this description contains many specifics, these should not be construed as limiting the scope of the invention but as merely providing illustrations of the presently preferred embodiments thereof, as well as the best mode contemplated by the inventors of carrying out the invention. The invention, as described and claimed herein, is susceptible to various modifications and adaptations, as would be understood by those having ordinary skill in the art to which the invention relates.

What is claimed is:

1. A log chipping machine for reducing a log having a log axis, said log chipping machine comprising:
(a) a frame having a long axis;
(b) a rotating chipping mechanism having an axis of rotation that is oblique to the long axis of the frame;
(c) a log advance system that is adapted to advance a log to the chipping mechanism, in a processing direction that is generally parallel to the long axis of the frame, said log advance system including an upper feed assembly;
(d) a control system comprising:
a lifting assembly that is adapted to move the upper feed assembly with respect to the frame between an engagement position in which the upper feed assembly contacts the log to advance it towards the chipping mechanism and a raised position in which the upper feed assembly is above and out of contact with the log;
(ii) a controller assembly that is operatively connected to the lifting assembly and adapted to cause the lifting assembly to move the upper feed assembly from the engagement position to the raised position intermittently in order to orient the log axis in a generally parallel relationship with the long axis of the frame as the log is being reduced.

2. The log chipping machine of claim 1 wherein the controller assembly is operatively connected to the log advance system and adapted to cause the log advance system to stop advancing the log to the chipping mechanism while the upper feed assembly is in the raised position.

3. The log chipping machine of claim 1 wherein:
(a) the upper feed assembly comprises:
(i) an upper feed roller;
(ii) a housing that partially encloses the upper feed roller;
(iii) a top bar that extends across the top of the housing from one side to the opposite side of the upper feed assembly;
(b) the lifting assembly comprises a pair of linear actuators that are located on opposite sides of the upper feed assembly, each of which is attached between the frame of the log chipping machine and the top bar.

4. The log chipping machine of claim 1 wherein the controller assembly is adapted to cause the lifting assembly to move the upper feed assembly from the engagement position to the raised position for a first predetermined time interval and to maintain the upper feed assembly at the raised position for a second predetermined time interval, at the end of which second predetermined time interval the controller will cause the lifting assembly to move the upper feed assembly from the raised position to the engagement position.

5. The log chipping machine of claim 4 wherein after the lifting assembly has moved the upper feed assembly from the raised position to the engagement position and thereafter a predetermined engagement period of time has elapsed, the controller assembly will cause the lifting assembly to move the upper feed assembly from the engagement position to the raised position.

6. The log chipping machine of claim 4 wherein the controller assembly comprises a programmable controller that an operator may use to set a first interval within a first predetermined range of intervals to define the time period between each actuation of the lifting assembly to move the upper feed assembly to the raised position and a second interval within a second predetermined range of intervals to define the time period that the upper feed assembly will be maintained in the raised position, and a timer for measuring the first interval and the second interval.

7. The log chipping machine of claim 6 wherein:
(a) the first predetermined range of intervals is 1.0-10.0 seconds, and the first interval may be selected in increments of 0.1 second within this first range;
(b) the second predetermined range of intervals is 1.0-3.0 seconds, and the second interval may be selected in increments of 0.1 second within this second range.

8. A log chipping machine for reducing a log having a log axis, said log chipping machine comprising:
(a) a frame having a long axis;
(b) a rotating chipping mechanism having an axis of rotation that is oblique to the long axis of the frame;
(c) a log advance system that is adapted to advance a log to the chipping mechanism, in a processing direction that is generally parallel to the long axis of the frame, said log advance system including an upper feed assembly;
(d) a control system comprising:
a lifting assembly that is adapted to move the upper feed assembly with respect to the frame between an engagement position in which the upper feed assembly contacts the log to advance it towards the chipping mechanism and a raised position in which the upper feed assembly is above and out of contact with the log;
(ii) a controller that is operatively connected to the lifting assembly and to the log advance system, said controller being adapted to cause the lifting assembly to move the upper feed assembly from the engagement position to the raised position intermittently and to hold the upper feed assembly at the raised position for a predetermined period of time while also causing the log advance system to stop advancing the log to the chipping mechanism while the upper feed assembly is in the raised position, after which the controller will move the upper feed assembly from the raised position to the engagement position.

9. The log chipping machine of claim 8 wherein the controller will cause the lifting assembly to move the upper feed assembly from the engagement position to the raised position every 3.0 seconds and will hold the upper feed assembly at the raised position for 1.0 seconds, after which the controller will move the upper feed assembly from the raised position to the engagement position.

10. A method for operating a log chipping machine to reduce a log having a log axis, said log chipping machine comprising:
(a) a frame having a long axis;
(b) a rotating chipping mechanism having an axis of rotation that is oblique to the long axis of the frame;
(c) a log advance system that is adapted to advance a log to the chipping mechanism, in a processing direction that is generally parallel to the long axis of the frame, said log advance system including an upper feed assembly;
(d) a lifting assembly that is adapted to move the upper feed assembly with respect to the frame between an engagement position in which the upper feed assembly contacts the log to advance it towards the chipping mechanism and a raised position in which the upper feed assembly is above and out of contact with the log;
wherein the method comprises:
(e) operating the rotating chipping mechanism;
(f) advancing the log to the chipping mechanism;
(g) causing the lifting assembly to move the upper feed assembly from the engagement position to the raised position intermittently.

11. The method of claim 10 which includes causing the log advance system to stop advancing the log to the chipping mechanism while the upper feed assembly is in the raised position.

12. The method of claim 10 which includes moving the upper feed assembly from the engagement position to the raised position every 3.0 seconds and holding the upper feed assembly at the raised position for 1.0 seconds, after which the upper feed assembly is moved from the raised position to the engagement position.

13. The method of claim 10 which includes causing the lifting assembly to move the upper feed assembly from the engagement position to the raised position for a first predetermined time interval and maintaining the upper feed assembly at the raised position for a second predetermined time interval, at the end of which second predetermined time interval the upper feed assembly is moved from the raised position to the engagement position.

14. The method of claim 13 which includes moving the upper feed assembly from the engagement position to the raised position after the upper feed assembly has been moved from the raised position to the engagement position and a predetermined engagement period of time has elapsed.
